(19) United States
(12) Patent Application Publication
(10) Pub. No.: US 2020/0175601 A1
(43) Pub. Date: Jun. 4, 2020

(54) SYSTEMS AND METHODS FOR TRANSFERRING DIGITAL ASSETS USING A DE-CENTRALIZED ESCROW SERVICE

(71) Applicant: Raistone, Inc., Los Angeles, CA (US)

(72) Inventor: Denis Letourneau, Los Angeles, CA (US)

(21) Appl. No.: 16/712,978

(22) Filed: Dec. 12, 2019

Related U.S. Application Data
(63) Continuation of application No. 14/864,631, filed on Sep. 24, 2015, now abandoned.
(60) Provisional application No. 62/201,425, filed on Aug. 5, 2015.
(60) Provisional application No. 62/057,512, filed on Sep. 30, 2014.

(51) Int. Cl. G06Q 40/06; G06Q 20/36; G06Q 20/38; G06Q 20/22

(52) U.S. Cl. CPC G06Q 40/06; G06Q 20/363; G06Q 2220/00; G06Q 20/223; G06Q 20/3829

(57) ABSTRACT

Systems and methods for transferring digital assets amongst a network of distributed users without the need to transfer the assets to an external party, such as an escrow agent, are provided. The transferring of assets may be in the form of electronic transactions between pluralities of currencies or assets. Temporary and localized escrow services may be created on a user terminal for safely overseeing the process of transferring digital assets. The trade instructions and execution orders for the transfer of assets may be validated over a de-centralized network of user terminals, such as the user terminals of traders. This type of network allows secure peer-to-peer electronic transactions to occur between distributed and anonymous users or participants, which are assumed to be trustless. In such networks, the transactions may be handled by cryptographic mathematical algorithms and which are known to be identical across all users or participants of the same network.

### CLAIM OF PRIORITY UNDER 35 U.S.C. § 119

The present application for patent claims priority to U.S. Provisional Application No. 62/201,425 entitled “SYSTEM, METHODS AND SOFTWARE APPLICATION FOR TRADING ELECTRONIC CURRENCIES WITH A DE-CENTRALIZED ESCROW SERVICE”, filed Aug. 5, 2015 and to U.S. Provisional Application No. 62/057,512 entitled “SYSTEM, METHODS AND SOFTWARE APPLICATION FOR TRADING ELECTRONIC CURRENCIES WITH A DE-CENTRALIZED ESCROW SERVICE”, filed Sep. 30, 2014, and both of which are hereby expressly incorporated by reference herein.

### FIELD

Various aspects of the present disclosure relate to financial transactions, and more specifically to systems and methods for trading digital assets using a de-centralized escrow service and online-financial methods, software applications and systems conducting business processing using cryptography.

### BACKGROUND

Web-based fully centralized trading exchanges for electronic currencies currently exist and allow trading of one type of electronic currency, such as Bitcoin, for another type. In such systems, prior to making any trades, traders have to transfer their electronic currencies from their personal electronic wallets or accounts, to electronic wallets (or digital wallets) controlled by an exchange, and located on central processing servers. Each exchange acts as an escrow agent for those funds, while trades are performed within the system. Those large amounts of electronic currencies pooled and kept in central locations, attract the attention of hackers and thieves alike. Despite high security measures taken by the exchanges to protect their plurality of wallets, their servers are frequently subject to cyber-attacks, or internal heists. If the attacks are successful, they may result in large amount of electronic currencies being stolen, and, following such events; exchanges are often forced to declare bankruptcy, with few chances for the traders to ever recover their funds.

In view of the foregoing, what is needed are systems and methods of transferring digital assets amongst a network of distributed users, such as traders, without the need to transfer the assets to an external party, such as an escrow agent or a remote exchange as well as online-financial methods, software applications and systems conducting business processing using cryptography.

### SUMMARY

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

According to one aspect, a computer implemented method for trading assets using a de-centralized escrow service is provided. The method includes receiving an electronic communication in a computer terminal where the electronic communication is a trade order for a pair of assets requested by a first user. The computer terminal includes a memory module, a wallet manager module, an order module, an order matching module, a clearing module and a settlement module. The method further includes installing a digital assets trading program on the user terminal; verifying the user terminal is fitted with a first digital wallet and a second digital wallet corresponding to the pair of assets using the wallet manager module; funding a first digital wallet on the computer terminal by securely transferring a first asset of the pair of assets to the first digital wallet and freezing an amount of the first asset to be traded for a second asset in the pair of assets; establishing a communication link to a central processing server and submitting the trade order to the central processing server using the order module; and receiving notification from the central processing server of a trade order match module using the order matching module.

According to one feature, the method includes confirming matching information received in the notification from the central processing server, the matching information is selected from at least the type of asset, conversion rates and amounts of the pair of assets are within boundaries of the trade order using the trade order match module.

According to another feature, the method includes generating a first set of cryptographic keys and a second set of cryptographic keys on the user terminal; and wherein the first user controls the first set of cryptographic keys and the digital assets trading program installed on the user terminal controls the second set of cryptographic keys.

According to yet another features, the method includes verifying availability of the amount of the first asset to be traded.

According to yet another feature, the method includes sending a first token having first token information to the second user using a de-centralized network of traders. The first token information includes de-centralized network of traders address of the first user, sending and receiving addresses of the first and second digital wallets of the first user, and a unique transaction identifier received from the central processing server.

According to yet another feature, the method includes receiving a second token having second token information from the second user using the de-centralized network of traders. The second token information includes de-centralized network of traders address of the second user, sending and receiving addresses of digital wallets of the second user, and the unique transaction identifier received from the central processing server.

According to yet another feature, the method includes verifying the unique transaction identifier received in the first token is the same as the unique transaction identifier in the second token and sending the amount of the first asset to the receiving address of a second user digital wallet of the second user.

According to yet another embodiment, the method includes receiving the second asset in the receiving address of second digital wallet of the first user and unfreezing the first and second digital wallets.

According to yet another feature, sending a copy of a signed transaction for the second asset to the central processing server for comparison to a copy of a signed transaction for the first asset from the second user and sending the second asset to the second user digital wallet after the central processing server confirms the validity of the copy of the signed transaction for second asset and the copy of the signed transaction for the first asset. The central processing server confirms the validity of the signed transactions by broadcasting the transaction on a first asset network and a second asset network. Once validity is confirmed, the receiving addresses of the second digital wallet of the first user is unfrozen.

According to another aspect, a computer terminal for trading assets using a de-centralized escrow service is provided. The computer terminal includes a processing circuit; a communications interface communicatively coupled to the processing circuit for transmitting and receiving information; and a memory communicatively coupled to the processing circuit for storing information. The processing circuit is configured to receive an electronic communication, the electronic communication is a trade order for a pair of assets requested by a first user; install a digital assets trading program on the user terminal; verify the user terminal is fitted with a first digital wallet and a second digital wallet corresponding to the pair of assets using a wallet manager module communicatively coupled to the processor; fund the first digital wallet on the computer terminal by securely transferring a first asset of the pair of assets to the first digital wallet and freezing an amount of the first asset to be traded for a second asset in the pair of assets; establish a communication link to a central processing server and submitting the trade order to the central processing server using an order module communicatively coupled to the processing circuit; and receive notification from the central processing server of a trade order match module using the order matching module.

According to one aspect, wherein the processor is further configured to confirm matching information received in the notification from the central processing server, the matching information is selected from at least the type of asset, conversion rates and amounts of the pair of assets are within boundaries of the trade order using the trade order match module.

According to another aspect, the processor is further configured to verify the availability of the amount of the first asset to be traded; send a first token having first token information to the second user using a de-centralized network of traders, where the first token information includes de-centralized network of traders address of the first user, sending and receiving addresses of the first and second digital wallets of the first user, and a unique transaction identifier received from the central processing server; receive a second token having second token information from the second user using the de-centralized network of trader, where the second token information includes de-centralized network of traders address of the second user, sending and receiving addresses of digital wallets of the second user, and the unique transaction identifier received from the central processing server; and verify the unique transaction identifier received in the first token is the same as the unique transaction identifier in the second token.

According to yet another aspect, the processor is further configured to send the amount of the first asset to the receiving address of a second user digital wallet of the second user; receive the second asset in the receiving address of second digital wallet of the first user; and unfreeze the first and second digital wallets.

### BRIEF DESCRIPTION OF THE DRAWINGS

FIG. 1 illustrates an example of a communication network connecting a plurality of computers to electronic asset networks and a remote central processing server, according to one aspect.

FIG. 2 illustrates an example of a communication network connecting a plurality of computers to a peer-to-peer decentralized network of traders (DNoT), according to one aspect.

FIG. 3 is a block diagram illustrating the internal functional architecture of a computer system usable with one or more aspects of the systems and methods of the present disclosure.

FIG. 4 is a simplified block diagram illustrating an example system for trading digital assets using a de-centralized escrow service on a user terminal.

FIG. 5 is a block diagram illustrating the stages of a method of trading digital assets using a de-centralized escrow service on a user terminal, according to one aspect.

FIG. 6 is a block diagram illustrating an alternate trade settlement process of the trading digital assets using a de-centralized escrow services on a user terminal, according to one aspect.

FIG. 7 is a block diagram illustrating the detailed process of the trade order process of the transfer of digital assets, according to one aspect.

FIG. 8 is a block diagram illustrating the detailed process of the trade order matching process of the transfer of digital assets, according to one aspect.

FIG. 9 is a block diagram illustrating the detailed process of the trade order clearing process of the transfer of digital assets, according to one aspect.

FIG. 10 is a block diagram illustrating the detailed process of the trade settlement process of the transfer of digital assets, according to one aspect.

FIG. 11 is a block diagram illustrating the detailed process of the alternate trade settlement process of the transfer of digital assets, according to one aspect.

FIGS. 12A and 12B are flow diagrams illustrating the transfer of digital assets, according to one aspect.

FIG. 13 is a diagram illustrating an example of a hardware implementation of a processing circuit for a system configured to trade digital assets using a de-centralized escrow service, according to one aspect.

### DETAILED DESCRIPTION

The following detailed description is of the best currently contemplated modes of carrying out the invention. The description is not to be taken in a limiting sense, but is made merely for the purpose of illustrating the general principles of the invention. Furthermore, in the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures and techniques may be shown in detail in order not to obscure the embodiments.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise. The word “exemplary” is used herein to mean “serving as an example, instance, or illustration.” Any implementation or embodiment described herein as “exemplary” is not necessarily to be construed as preferred or advantageous over other embodiments or implementations. Likewise, the term “embodiments” does not require that all embodiments include the discussed feature, advantage or mode of operation.

The term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another, even if they do not directly physically touch each other.

The term “assets” or “digital assets” may refer to any tangible or intangible asset that can be listed on electronic ledgers including, but not limited to, currencies, electronic currencies, bonds, stocks, patents, copyrights, buildings, vehicles, equipment, digital documents having a financial value such as mortgages, insurance documents, titles, contracts or digital tokens representing such assets. The term “electronic currency” may refer to virtual currency, crypto-currency, digital currency, digital tokens or any other electronically created and stored medium of exchange. In some examples, the term “assets” may refer to a tangible currency of a country such as the United States Dollar (S) of the United States of America.

Various aspects are described herein in connection with a computer or a terminal, which can be a wired terminal (wired computer) or a wireless terminal (wireless computer). The term “computer”, “terminal” or “computer terminal” may refer to any device or devices having at least one processing element and capable of carrying out a set of instructions such as arithmetic or logical operations. As used herein, the terms “computer”, “terminal” or “computer terminal” may also be called, for example, a system, device, subscriber unit, subscriber station, mobile station, mobile, mobile device, remote station, remote terminal, access terminal, user terminal, communication device, user agent, user device, user equipment (UE), a Personal Computer (PC), a mobile computer, a laptop computer, a handheld computer, a notebook computer, a tablet computer, a wireless device, a mobile phone, a mobile communication device, a user communication device, personal digital assistant, mobile palm-held computer, a workstation, and/or a server.

The terms “electronic wallet” or “digital wallet” may refer to a file that contains a collection of private cryptographic keys secured on a computer, electronic device, or virtual container within an electronic device for storing information related to an electronic commerce transaction. The digital wallet is securely linked to the digital assets of a user. The assets are recorded on a distributed block chain ledger, and by the use of those cryptographic keys users are able to transfer the ownership of those assets. The digital assets trading program or system may incorporate a multitude of different asset digital wallets. Alternatively, the digital wallets of existing third-parties already installed on the user terminal may be utilized.

The term “smart contract” may refer to computer protocols and code that facilitate, verify, or enforce the negotiation or performance of a contract, or that obviate the need for a contractual clause. Smart contracts typically utilize a user interface and often emulate the logic of a contractual clause. Smart contracts can be embedded on a network block chain, like Ethereum, and may be selectively executed by the nodes of the same network.

Throughout this disclosure, the use of the term “user” may refer to a consumer, a broker, a trader, a participant, a network participant, a party, a bidder, or any other individual or entity capable of performing a digital transaction.

Throughout this disclosure, the use of the terminology “de-centralized network of traders (DNoT)” may refer to a plurality of users that can transfer digital assets amongst each other without the need to transfer the assets to an external party (or a third party), such as an escrow agent or a remote Exchange.

Throughout this disclosure, use of the terms “transfer” and “transferring” may refer to but are not limited to, transact, transacting, trade, trading, pay, paying payment, process or processing.

The term “block chain” may refer to a distributed ledger that records peer-to-peer digital asset transactions such as Bitcoin transactions.

The various concepts presented throughout this disclosure may be implemented across a broad variety of telecommunication systems, network architectures, and communication standards.

While the present description is described primarily with respect to the features of digital currency exchange and traders trading digital currency, the present description may be applied and adapted to assets transferred or traded between banks or other entities, when facilitated by a third party, between traditional brokers or brokerage houses when facilitated by an exchange system or may be applied to services provided by banks or other entities to its customers/account holders.

According to one example, the novel aspects of the present disclosure may be utilized by a bank (which may provide the same services as an exchange) allowing its account holders to move/trade United States currency (USS) to a digital currency, such as Bitcoins, and vice versa by trading via the bank amongst other account holders of the bank who may behave as traders on the DNoT.

### Overview

Systems and methods for transferring digital assets amongst a network of distributed users without the need to transfer the assets to an external party, such as an escrow agent or a remote Exchange, are provided. The transferring of assets may be in the form of electronic transactions between pluralities of currencies or assets. Also, online-financial methods, software applications and systems conducting business processing using cryptography are provided.

In the present disclosure, temporary and localized escrow services may be created on a user terminal (i.e. a computer of a participant, user or trader) for safely overseeing the process of transferring digital assets. The trade instructions and execution orders for the transfer of assets may be validated over a de-centralized network of user terminals, such as the user terminals of traders. This type of network allows secure peer-to-peer electronic transactions to occur between distributed and anonymous users or participants, which are assumed to be trustless. In such networks, the transactions may be handled by cryptographic mathematical algorithms, similar to those of the Bitcoin or Ethereum network, and which are known to be identical across all users or participants of the same network. Any attempt by one user or participant that is involved in the process of trading digital assets using de-centralized escrow services to modify the algorithms of the process may cause the network to reject any transaction generated by dissimilar algorithms.

According to one aspect, the transfer of digital assets using a de-centralized escrow service may include separate and distinct stages. For example, the separate and distinct stages may include: (1) issuance of trade orders; (2) trade matching; (3) trade clearing; and (4) trade settlement. For the successful transfer of assets, both participants to the transaction need the assurance that the assets put for bids exist, are committed, and that they are held by a trusted escrow until final settlement.

Upon initiating a trade order on a user terminal, the user terminal may first identify if the digital assets trading program or system for performing the transfer of digital assets using a de-centralized escrow service is installed. In one example, the digital assets trading program or system may act as an escrow node over a de-centralized network of traders (DNoT).

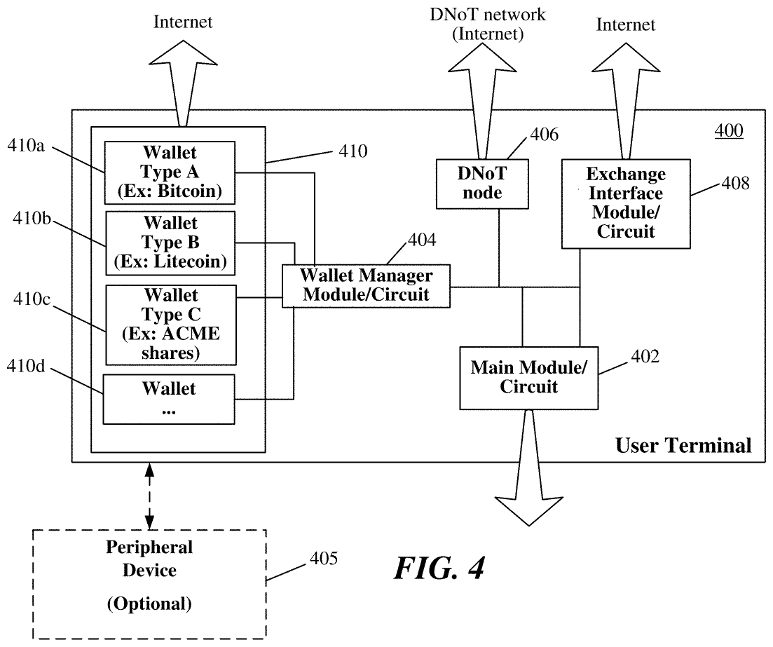

FIG. 4 is a simplified block diagram illustrating an example system for trading digital assets using a de-centralized escrow service on a user terminal. According to one aspect, downloading or installation of the digital assets trading program or system forms localized escrow services on the user terminal. The localized escrow services may generate cryptographic keys on the user terminal only known to the user terminal for the locking and unlocking of the assets to be traded based upon pre-determined set of computer instructions received. Alternatively, a private signature unique to the user terminal may be utilized in network systems having simple multi-signatures capabilities.

The digital assets trading program may imbed the de-centralized network of traders (DNoT) communication and algorithms, on the user terminals, that allow the processing and validation of all successful trade matches received by the network on the user terminals. Each user terminal may have a working copy of the digital assets trading program allowing all the user terminals in the DNoT to communicate together using via a network, such as the Internet. Alternatively, the trade matching specifications and instructions may be embedded in the block chain of an existing or dedicated network, such as a smart contract, similarly to the smart contracts of the Ethereum network.

To utilize the systems and methods of the present disclosure, a trader, via a user terminal, must first be willing to trade an asset and transfer the asset to a digital wallet or other secure location on the user terminal which is installed with the digital assets trading program. The assets transferred to the secure location for trading must total an amount that is sufficient to cover the intended trade. The digital wallet, or other secure location on the user terminal, may receive the electronic assets and display the value of the assets on a display screen of the user terminal. The digital wallets on the user terminals may be sourced, or act similarly, as existing Electrum software application, to allow quick synchronization to the corresponding asset networks.

Trade Order and Matching

During the trade order process, buy (bid) and sell (ask) orders may be placed by users, such as traders, on a user terminal for a given pair of assets at a requested exchange rate. The trader may determine which assets are to be traded and place an order using the digital assets trading program on the user terminal. The pair of assets may include a first asset that the user is trading to obtain a second asset. For example, the user may wish to trade Asset B, which is owned by the user, to obtain Asset A which is owned by a different user.

If not already installed on the user terminal, the digital assets trading program may automatically be downloaded from a remote central processing server, when the order is initiated, along with the respective electronic or digital wallets for the requested assets to be traded or alternatively, a link may be created to pre-existing or pre-installed wallets on the user terminal. The trader may then transfer the desired quantity of electronic assets to be traded from personal digital wallets, or online accounts, to the digital wallets associated with the digital assets trading program.

Next, the digital assets trading program or system may establish and maintain a communication link to a central processing server, which maintains a plurality of Order Market databases, with graphical and tabular representations of opened and closed orders being traded, for a plurality of electronic asset pairs placed for orders by a plurality of different traders. That is, the central processing server may maintain a list of trader orders on one or more Order Market databases. Communication between the user terminal and the central processing server may occur using normal secured channels over a network, such as the Internet. A trader can place a plurality of Bid and/or Ask orders using the digital assets trading program or system on the user terminal as long as enough electronic assets are available in the wallets, to cover each bid. Upon receiving a request by the user to submit a bid, the digital assets trading program or system on the user terminal may use its generated private keys, which are encrypted, to lock (freeze) the amount of the bided asset, in the sending wallet, and also may lock the deposit address of the corresponding receiving asset wallet.

The utilization of the above process commits the necessary amounts of assets to the bid, for both parties, and creates a localized escrow service for each bid. This function ensures, that if an amount of asset is received from a trade, before the corresponding traded asset is sent out, the received asset will not be able to be spent or accessed, and therefore will have no value to the receiver until the corresponding traded asset is sent out to the buyer. At any time before an order matching is found, the order may be cancelled, the escrow service terminated, and the assets unlocked and recovered.

Once the trade matching process of the central processing server finds a partial, or complete match between a Buy and a Sell order, it may relay to each respective user terminal (i.e. the Buyer's user terminal and the Seller's user terminal) the detailed specifications of the matching trade with a unique transaction identifier.

Trade Clearing

During the trade clearing process, the digital assets trading program or system on the user terminal may be notified by the central processing server that a trade match has occurred and provide the corresponding matching specifications. The digital assets trading program or system on the user terminal may then validate the received information from the central processing server, to confirm, amongst other things, that the asset type, conversion rates, and amounts are within the boundaries of the requested bid. Next, the digital assets trading program or system on the user terminal may send a token to the user terminal of the other trader using the de-centralized network of traders (DNoT). The token may include such information as the respective DNoT addresses of the user terminals of the traders, the sending and receiving address of each asset wallets, and their amount, along with the unique transaction identifier received from the central processing server. The user terminal of the other party involved in the trade may then send a similar token to the user terminal of the first party, with the same information, using the de-centralized network of traders (DNoT).

Trade Settlement

During the trade settlement process, the digital assets trading program or system on the user terminal of each party involved in the trade may receive each other's token that contains the same information, and detects that both token transactions are validated by the DNoT network. Once both token transactions are validated, the trade may be cleared and the trade settlement process can proceed.

Next, the digital assets trading program or system on the user terminal of each party may transfer its respective electronic asset, as per the specifications of the matching trade, using the respective networks associated with each electronic asset. Each user terminal of the parties may receive its respective traded electronic assets. When both the electronic transactions are confirmed on their respective networks, the digital assets trading programs or systems on the user terminals may un-lock both local asset wallets and free access is now available to new electronic assets on each respective user terminal.

Alternate Trade Settlement

An alternative trade settlement process on the user terminals may be used when one or more of the user terminals may be at risk of being compromised, which could result in the digital assets trading program or system on the user terminal being modified maliciously. In the alternative trade settlement process, a wallet manager module (or circuit) on the user terminal of one trader may apply the required cryptographic signatures to the matched transaction, which may then pay the amount of traded electronic asset to the receiving address specified by the trade. Instead of the signed transaction being broadcast on the respective network, the user terminal of the trader may send a copy of the signed transaction to the central processing server. Furthermore, the user terminal of the trader may also send another signed transaction with the amount of the trading fee to the receiving address, which was specified by the central processing server. The user terminal of the other trader may execute similar instructions with its electronic asset, and send a copy of its signed transaction to the central processing server. The central processing server may wait until both signed transactions are received.

Next, the central processing server may verify on both networks block chains that the electronic assets are still available (i.e. not spent) and that both transactions still conform to the matched trade. Once the information is verified, the central processing server may broadcast both transactions on the respective networks and broadcast the trading fee transaction. Once both the received and sent currencies transactions are confirmed on both networks, the wallet manager module (or circuit) of each user terminal may unlock the received electronic asset and each trader, via its own user terminal, may now have now free access to their new electronic asset.

Communication Network

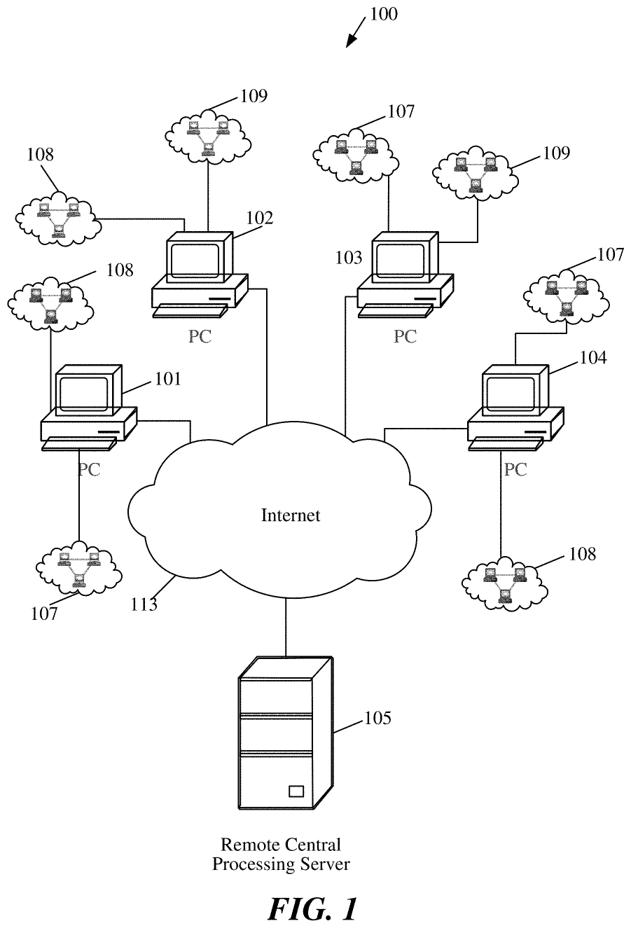

FIG. 1 illustrates an example of a communication network connecting a plurality of user terminals to electronic asset networks and a remote central processing server, according to an exemplary embodiment. As shown, the communication network 100 may include a plurality of user terminals 101-104 connected to a remote central processing server 105 via a network 113, such as the Internet. According to one aspect, each user terminal in the plurality of user terminals 101-104 may be connected to a multitude of electronic asset networks simultaneously 107-110, respectively.

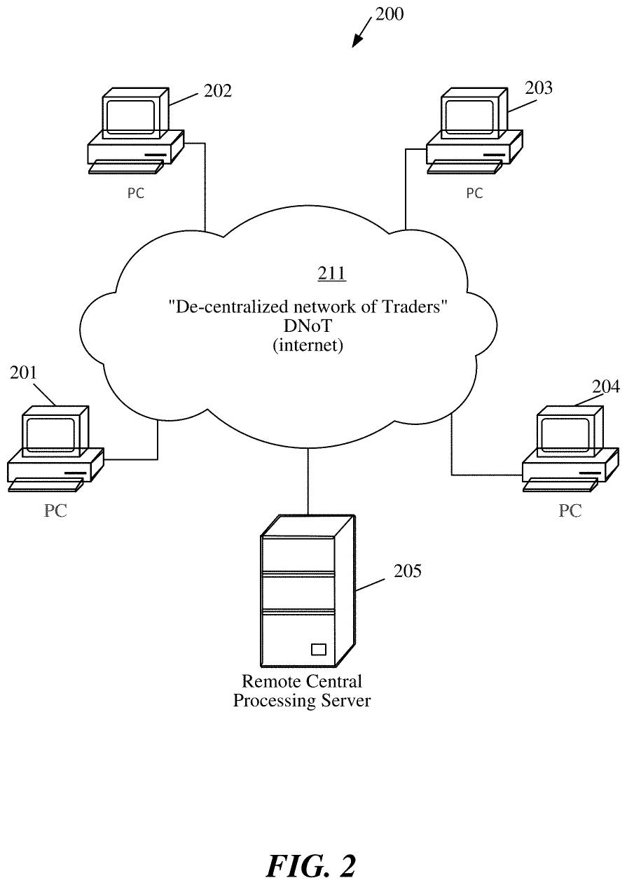

FIG. 2 illustrates an example of a communication network connecting a plurality of computers to a peer-to-peer decentralized network of traders (DNoT), according to an exemplary embodiment. As shown, the communication network 200 may include a plurality of user terminals 201-204 connected to a remote central processing server 205 via a network 211, such as the Internet, forming a de-centralized network of traders (DNoT).

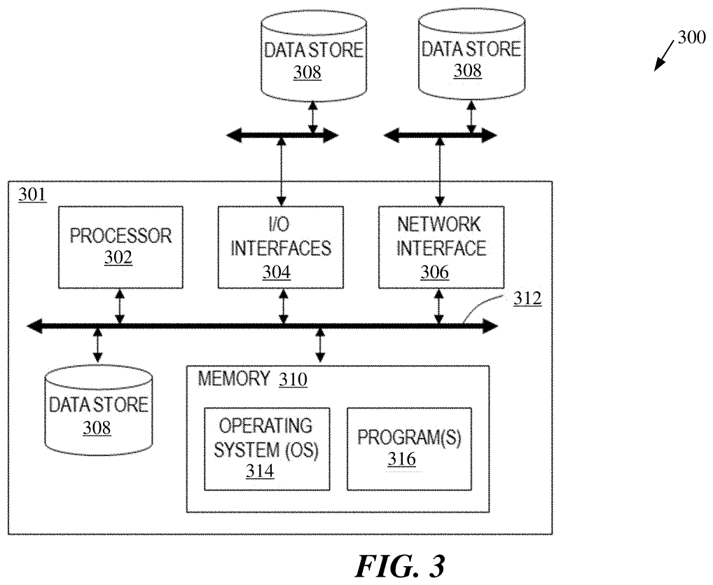

FIG. 3 is a block diagram illustrating the internal functional architecture of a computer system 300 usable with one or more aspects of the systems and methods described in further detail below. For example, the user terminals 301 in the computer system 300 of FIG. 3 may be deployed in each of the plurality of user terminals 101-104, 201-204 and the central processing servers 105, 205 of FIGS. 1 and 2.

The user terminals 301 may be a digital computer that, in terms of hardware architecture, generally includes a processor 302, input/output (I/O) interfaces 304, a network interface 306, a data store (or database) 308, and memory 310. It should be appreciated by those of ordinary skill in the art that FIG. 3 depicts the user terminals 301 in an oversimplified manner, and a practical embodiment may include additional components and suitably configured processing logic to support known or conventional operating features that are not described in detail herein. The components 302, 304, 306, 308, and 310 may be communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the computer, a semiconductor-based microprocessor (in the form of a microchip or chip set), or generally any device for executing software instructions. When the user terminal 301 is in operation, the processor 302 may be configured to execute software stored within the memory 310, to communicate data to and from the memory 310, and to generally control operations of the user terminal 301 pursuant to the software instructions. The I/O interfaces 304 may be used to receive user input from and/or for providing system output to one or more devices or components. User input may be provided via, for example, a keyboard, touch pad, touch screen, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the computer to communicate on a network, such as the Internet, a wide area network (WAN), a local area network (LAN), and the like, etc. The network interface may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n/ac). The network interface 306 may include address, control, and/or data connections to enable appropriate communications on the network. A data store (or database) 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store may incorporate electronic, magnetic, optical, and/or other types of storage media. In one example, the data store 308 may be located internal to the user terminal 301 such as, for example, an internal hard drive connected to the local interface in the computer. Additionally in another embodiment, the data store may be located external to the user terminal 301 such as, for example, an external hard drive connected to the I/O interfaces (e.g., SCSI or USB connection). In a further embodiment, the data store 308 may be connected to the computer through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor. The software in memory may include one or more software programs, each of which includes an ordered listing of executable instructions for implementing logical functions. The software in the memory 310 includes a suitable operating system (O/S) 314 and one or more programs 316. The operating system 314 essentially controls the execution of other computer programs, such as the one or more programs, and provides scheduling, input-output control, file and data management, memory management, and communication control and related services. The programs 316 may include various applications, add-ons, etc. configured to provide end user functionality with the mobile devices. For example, exemplary programs may include, but not limited to, a web browser, social networking applications, streaming media applications, games, mapping and location applications, electronic mail applications, financial applications, and the like. In a typical example, the end user typically uses one or more of the programs along with a network such as the system. The one or more programs may be configured to implement the various processes, algorithms, methods, techniques, etc. described herein.

### Cryptographic Keys Generation

Upon installing the digital assets trading program or system on the user terminal, multiple cryptographic keys may be generated. According to one example, three (3) sets of cryptographic keys may be generated. A user, such as a trader, may control one (1) set of cryptographic keys and the digital assets trading program or system may control a second set of cryptographic keys, which in this later case, is self-generated and known only by the digital assets trading program or system. The third set of cryptographic keys may be generated and stored away, to be used as a backup. According to one example, to initiate any transaction, a minimum of two (2) sets of private cryptographic keys may be required.

FIG. 4 is a simplified block diagram illustrating an example system for trading digital assets using a de-centralized escrow service on a user terminal. The user terminal 400 (for example user terminals 101-104 and 201-204 in FIG. 1 and FIG. 2, respectively, allows for a trader (or user) to view orders, trades and market prices that are available from the central processing server 105, 205, or other source, and may submit Buy/Sell orders to the central processing server 105, 205, in a plurality of electronic asset pairs.

As shown, the system for trading digital assets using a de-centralized escrow service on the user terminal 400 may include a main module (or circuit) 402 for communicating with and providing instructions to a wallet manager module (or circuit) 404, a DNoT node 406 and an exchange interface module (or circuit) 408. The wallet manager module (or circuit) 404 may communicate with and provide instructions to a wallet module (or circuit) 410 of the trader (or user) located on the user terminal. The wallet module (or circuit) 410 may include multiple electronic wallets 410a-410d linked to different types of assets. For example, as shown, an electronic wallet may include a wallet having a first type (Type A) of assets, a second type (Type B) of assets, a third type (Type C) of assets or any other type of asset. According to one aspect, type A could be Bitcoin, type B could be Litecoin, and type C could be public shares of ACME Inc., and the trader may want to trade Bitcoins for ACME shares. All types of electronic assets may communicate with their respective and dedicated peer-to-peer network, using the Internet and methods similar to the DNoT.

According to one aspect, the digital assets trading program or system may optionally be located on a removable peripheral device 405 which may be communicatively coupled to the user terminal. Storing the digital assets trading program or system on a removable peripheral device allows for the portability of the digital assets trading program or system.

### Method of Trading Assets

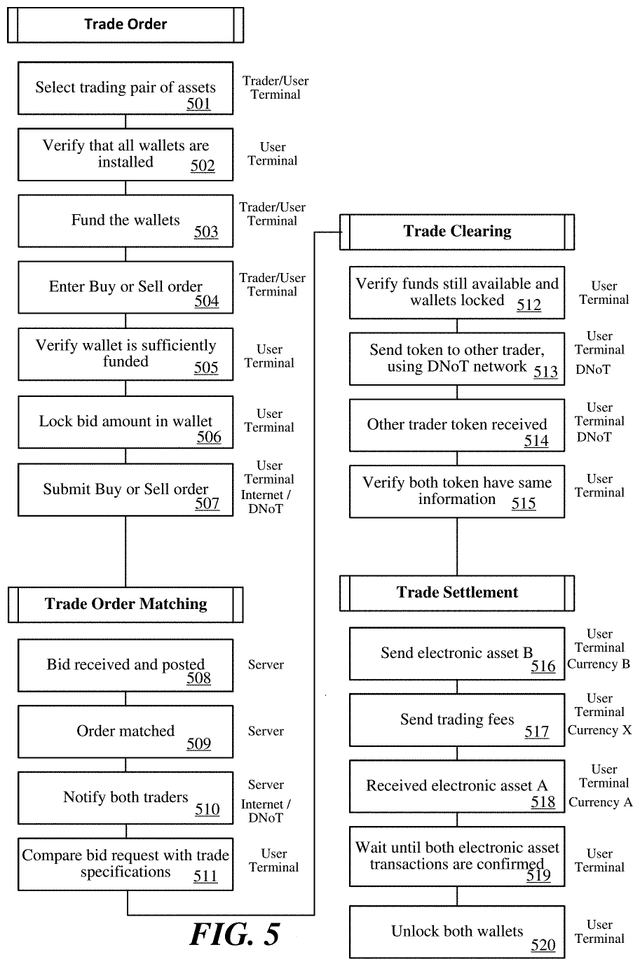

FIG. 5 is a block diagram illustrating the stages of a method of trading digital assets using a de-centralized escrow service on a user terminal according to the present disclosure.

### Trade Order Issuance

The first stage in the process of the transfer of digital assets using a localized de-centralized escrow service on a user terminal occurs when a trader issues or requests a trade order. First, the wallet manager module (or circuit) 404 on the user terminal, based on input from a user, may select a pair of assets to be traded 501. Next, verification that the user terminal of the trader is fitted with the wallets corresponding to the selected electronic asset pair that is to be traded occurs 502. If a determination is made that the user terminal of the trader is not fitted with the wallets corresponding to the selected electronic asset pair that is to be traded, the wallet manager module (or circuit) 404 of the user terminal may download and install the missing wallets on the user terminal of the trader.

Next, the trader may fund the wallets associated with the trade on its user terminal 503. The wallets may be funded by transferring sufficient assets from personal wallets, or accounts, which may or may not be located on the same user terminal, to electronic asset wallet(s) associated with the trade installed on the user terminal of the trader. The wallets are funded with a sufficient amount of assets to complete the intended trade. Through the graphical and tabular interface of the digital assets trading program or system on the user terminal, the trader may submit a Buy or Sell order 504. Upon receiving instructions to trade a given amount of electronic assets for a different type of electronic asset, at a desired trading rate or price, the wallet manager module (or circuit) on the user terminal may verify that the respective electronic asset wallet is sufficiently funded 505 with the amount corresponding to the desired bid. According to one example, the wallet manager module (or circuit) on the user terminal may also verify that the respective electronic asset wallet also includes sufficient assets to cover the eventual trading fees and associated electronic asset network transaction fees.

Upon verifying that the wallet is sufficiently funded, the wallet manager module (or circuit) of the user terminal may freeze the equivalent amount of assets in the wallet 506 that are to be traded preventing the cryptographic key, or aggregation of keys, associated with the traded amounts to be used for any other transaction than the committed bid. The digital assets trading program or system of the user terminal may also freeze the deposit address of the asset to be acquired ensuring that the bid is committed and that sufficient amount of assets will be available for the final trade settlement process, whenever the bid is matched—the digital assets trading program or system of the user terminal acting as a local escrow service.

The digital assets trading program or system of the user terminal may then submit a Buy or Sell order 507, which may be encrypted, to the central processing server. The order transmitted to the central processing server may include information such as (1) the type of electronic asset to trade; (2) the amount of electronic asset to Buy, or Sell; (3) the desired exchange rate/price of the trade; (4) the desired electronic asset wallet deposit address or public key, which is specific to the electronic asset network type, and/or; (5) a unique self-generated transaction identifier, which may include the trader identifier corresponding to a DNoT network public key, as generated by the wall manager module (or circuit) and the DNoT node on the user terminal of the trader. The identifier may be different for every bid order.

Alternatively, or jointly, the user terminal of the trader may send a distinct token on the DNoT network, which may include the bid specifications, as described above. The instructions may alternatively be embedded in the block chain of the DNoT network, in a smart contract format, as specified by the network used.

### Trade Order Matching

The next stage of the process of the transfer of digital assets is trade order matching. Upon receiving a Buy or Sell order, either through the Internet, or alternatively from the DNoT network, the central processing server may send a confirmation message to the digital assets trading program or system of the user terminal of the trader to indicate that the bid has been received and added to the Order Market 508 on the server. If the trader cancels a bid before an order has been matched, the central processing server may remove the bid from the Order Market and send a message to the user terminal of the trader causing its wallet manager module (or circuit) to unfreeze the amount of the bid in the respective wallet.

The central processing server may manage the orders received by all system participants (i.e. user terminals) in the selected trading pair and attempt to match orders received. Once a trade match has been found 509, the matching trade may be removed from the Order Market and the central processing server may send a transaction message to each user terminal of the traders involved in the trade (for example traders 101 and 104 in FIG. 1), which includes the trade specifications 510. Alternatively, or jointly, the central processing server, may send a distinct DNoT token on the DNoT network, which may include the trade specifications. The instructions may alternatively be embedded in the block chain of the DNoT network, in a smart contract format, as specified by the network used. The block chain of an electronic asset network is equivalent to its public ledger, where a record of all validated transactions appear. All participants in the network maintain a local copy of the block chain, or its index.

According to one aspect, a matching trade may comprise a partial amount of the original bid or ask order, and, in such a case, the central processing server may automatically put the unmatched difference between the original bid amount and the matched bid amount, back on the Order Market database.

The transaction message sent to each user terminal trader may be encrypted and may include information, including but not limited to, (1) a trade identifier, self-generated by the central processing server, and unique to the trade; (2) the amount of each electronic asset traded; (3) the type of each electronic asset traded; (4) both traders receiving addresses (public keys of each dedicated types of electronic asset traded); (5) individually to each trader, the return of their unique transaction self-generated identifier, which was initially submitted with their bids; and/or (6) both traders unique trader identifier (DNoT public keys).

Upon receiving the trade-matching message from the central processing server, either through the Internet, or the DNoT network, the digital assets trading program or system on the user terminal may compare it to the initial bidding message that was sent to the central processing server 511. The digital assets trading program or system on the user terminal may verify that information between the two messages is accurate. The information may include, but is not limited to, (1) trader identifier, and/or unique transaction identifier; (2) type of electronic asset, amount and rate; and/or (3) amounts do not exceed the original bid, less any partial executed amounts previously.

If all the information matches, the digital assets trading program or system on the user terminal may conclude that a trade order match did happen, and then proceed to the trade clearing process, to verify that the funds of both traders are still available, are still held in escrow by the digital assets trading programs or systems on the user terminals of the traders, and are ready to be sent as part of the settlement process.

### Trade Clearing

The next stage in the process of the transfer of digital assets using a de-centralized escrow services on a user terminal is trade clearing. In this stage, the user terminal may verify that the electronic asset funds required for the trade are still available and if available, frozen by the wallet manager module (or circuit) on the user terminal 512. Using the decentralized network of traders (DNoT), each user terminal, such as 101, 104, 201, 204 in FIGS. 1 and 2, that has received the matching trade message from the central processing server, independently from each other, may send a token to a second trader DNoT public address 513, with exactly the same information. This information may include, but is not limited to, (1) the transaction identifier, unique to this trade, as generated and received from the central processing server; (2) both types of electronic assets that form part of the trade; (3) both amounts of electronic assets that form part of the trade; (4) the trade rate/price of the trade; and/or (d) both electronic asset wallet addresses (public key) that are used for receiving the traded currencies at each end.

Next, each node of the network of traders (DNoT) may communicate between each other using a network, such as the Internet, and execute the same digital assets trading program or system. The instructions could alternatively be embedded in the block chain of the network, in a smart contract format, as specified by the network used. The network nodes may validate all tokens and transactions being processed by the network, regardless of their origin or destination, similar to the Bitcoin or Ethereum network.

Next, upon receiving a DNoT token from the user terminal of a second trader trader 514, the digital assets trading program or system on the user terminal of the first trader may verify that it contains the information from one of its trade, and that it matches exactly the information that was sent to the second trader. The digital assets trading program or system may wait until the network confirms both token transactions on the DNoT block chain 515. In such networks, it may be usual to wait until all the nodes on the network receive 3 to 6 confirmations before declaring a transaction confirmed. Although 3 to 6 confirmations are described, this is by way of example only and there may be less than 3 confirmations or more than 6 confirmations. Once confirmed, the digital assets trading program or system on the user terminal may conclude that the user terminal of the second trader exists and is still active on the network, that the trade matching specifications are valid, that both traded currencies are available in sufficient amount, and are properly held in escrow by the respective digital assets trading programs or systems on the user terminals. The user terminals may then proceed to the trade settlement.

### Trade Settlement

The next stage in the process of the transfer of digital assets using a de-centralized escrow services on a user terminal is trade settlement. In the process of trade settlement, the wallet manager module (or circuit) of the user terminal of one trader may apply the required cryptographic signatures to the transaction and broadcast the required amount of traded electronic assets to the respective receiving address (public key) of the respective network, such as network 107 in FIG. 1, as specified by the trade message 516 received from the central processing server. It may also send the amount of the trading fee to the receiving address, which was specified by the central processing server 517. The user terminal of the second trader may execute similar instructions with the other electronic asset network, such as network 108 in FIG. 1. The user terminal may wait until the transferred electronic asset is also received 518 by the respective trader. Once both the received and sent currency electronic assets transactions are confirmed 519, on both networks, the wallet manager module (or circuit) on the user terminal may unlock the received electronic asset 520. The trade has been completed successfully and the traded currencies assets can be used for further trading, or sent to other wallets.

### Alternate Trade Settlement

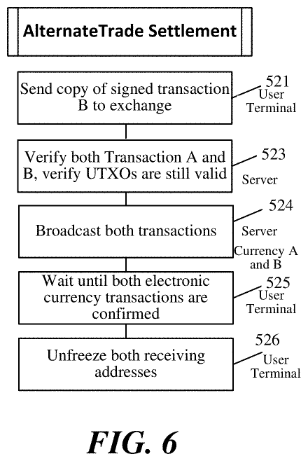

FIG. 6 is a block diagram illustrating an alternate trade settlement process of the trading digital assets using a de-centralized escrow services on a user terminal, according to one aspect. This alternative embodiment may be used when the user terminals may be at risk of being compromised, which would result in the digital assets trading programs or systems on the user terminals being modified maliciously.

In the alternative settlement process, after the network confirms both token transactions on the DNoT block chain 515, the wallet manager module (or circuit) of the user terminal of one of the traders may apply the required cryptographic signatures to the matched transaction, which pays the amount of traded electronic asset to the receiving address specified by the trade. Instead of broadcasting the signed transaction on the respective network, the user terminal of the trader may send a copy of the signed transaction to the central processing server. It may also send another signed transaction with the amount of trading fee to the receiving address which was specified by the central processing server 521. The user terminal of the second trader may execute similar instructions with the other electronic asset, and send a copy of its signed transaction to the central processing server. The central processing server software application may wait until both signed transactions are received 521. The central processing server may verify on both networks block chains that the electronic assets are still not spent and that both transactions conform to the matched trade 523. Once the information is verified, the central processing server may broadcast both transactions on the respective networks 524 and broadcast the trading fee transaction. Once both the received and sent currency transactions are confirmed 525 on both networks, the wallet manager module (or circuit) on the user terminal may unlock the received electronic asset 526.

### Trade Order Process

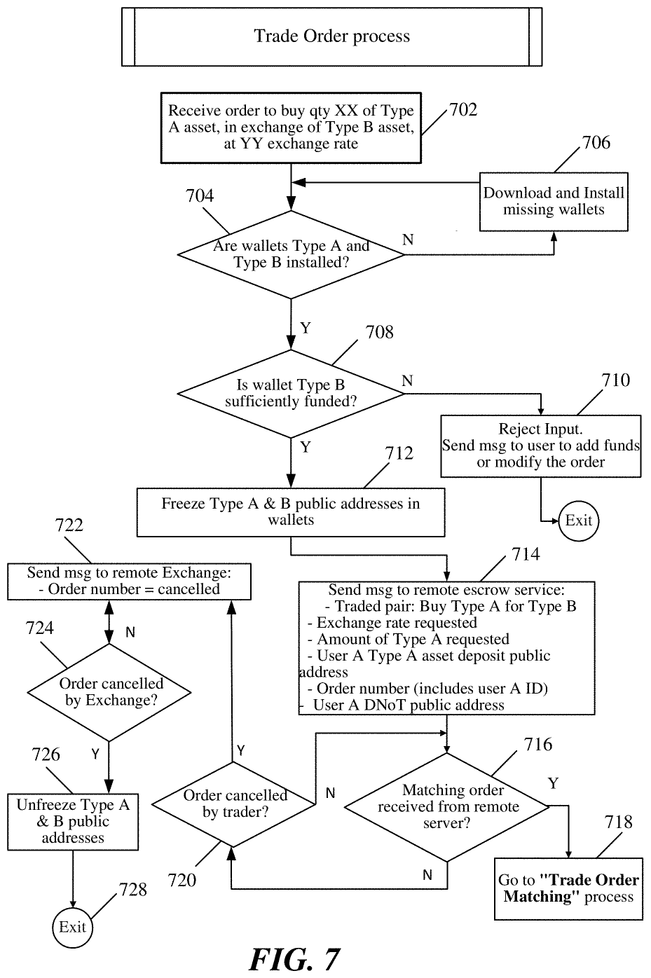

FIG. 7 is a block diagram illustrating the detailed process of the trade order process of the transfer of digital assets, according to one aspect. First, an order to buy or purchase a specific quantity of a first type of asset (e.g. Type A) in exchange for a second type of asset (e.g. Type B) at a specific exchange rate is received or placed on a user terminal 702. The user terminal may then determine if a digital wallet associated with the first type of asset (Type A) and a digital wallet associated with the second type of asset (Type B) is installed on the user terminal 704. If one or more wallets associated with the types of assets being exchanged are missing from the user terminal, the user terminal may then download and install the one or more missing wallets 706.

Once wallets for each type of asset to be exchanged/transferred/purchased in the trade order have been identified, a determination is made as to whether the wallet for the second type of asset (Type B), which will be used to exchange/transfer/purchase for the first type of assets (Type A), is fully funded 708. If the wallet for the second type of asset (Type B) is not sufficiently funded, a message may be sent to the user via the user terminal to add funds to the wallet for the second type of asset (Type B) or modify or cancel the order 710. If the wallet for the second type of asset (Type B) is sufficiently funded, the public addresses in the wallets for both the first type (Type A) and the second type (Type B) may be frozen 712.

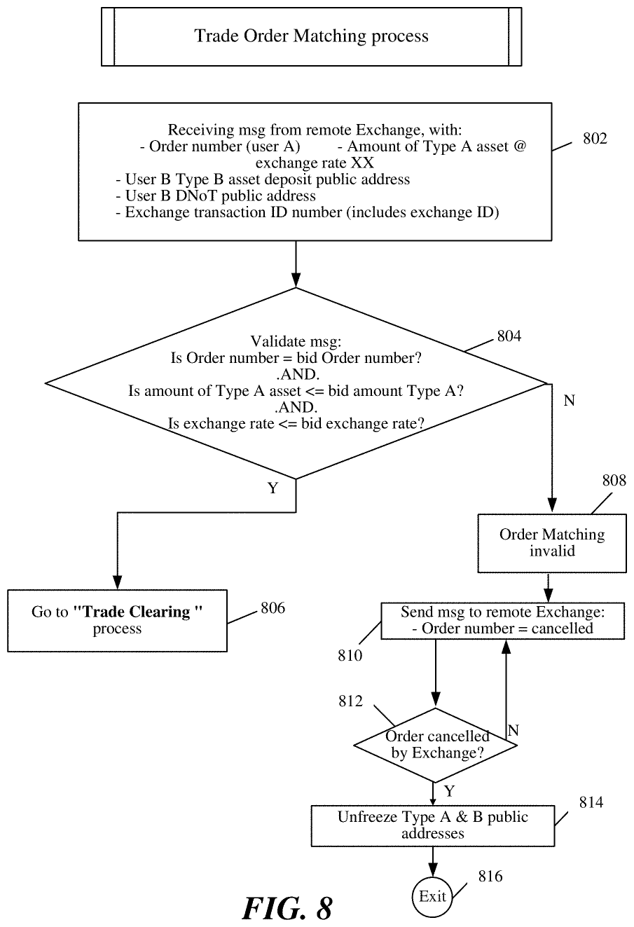

After freezing the public addresses of the wallets, a message may be sent to the remote exchange (or the remote central processing server) 714. The message may include the exchange rate requested, the amount of the first type of asset (Type A) requested, the deposit public address of the user (User A) which owns the first type (Type A) asset, the order number (including the ID of User A) and the DNoT public address of the user (User A). Next, a determination may be made as to whether or not a matching order has been received from the remote exchange 716. If a match has occurred, the process of trading digital assets using a de-centralized escrow services on the user terminal proceeds to the “Trade Order Matching” process 718 as described below with reference to FIG. 8.

If a match has not occurred or is not found after a pre-determined amount of time, the order may be cancelled by the user (or trader) via the user terminal 720. Until the order has been cancelled by the trader or a pre-determined amount of time has elapsed, whichever occurs first, the search for a matching order continues. Once an order has been cancelled, a message may be sent to the remote exchange by the user terminal indicating that the order has been cancelled 722. Until confirmation from the remote exchange has been received acknowledging the order cancellation 724, the cancellation message 722 may continue to be sent to the remote exchange at periodic intervals. Upon receiving confirmation of the order cancellation from the remote exchange, the user terminal may unfreeze the Type A and Type B public addresses 726 and the process is terminated 728.

### Trade Order Matching Process

FIG. 8 is a block diagram illustrating the detailed process of the trade order matching process of the transfer of digital assets, according to one aspect. Once a trade order match has been found by the remote exchange, the user terminal may receive a message from the remote exchange 802. As described above, the message may include the following information: (1) the order number (transaction identifier, unique to this trade) for the first user (User A); (2) the amount and type of asset (Type B) to be traded, the type of asset (Type A) to be acquired and the exchange rate (XX) at which it will be traded; (3) the desired electronic asset wallet deposit public address or public key; (4) User B DNoT public address; and/or (5) the exchange transaction identifier number, including the exchange identifier.

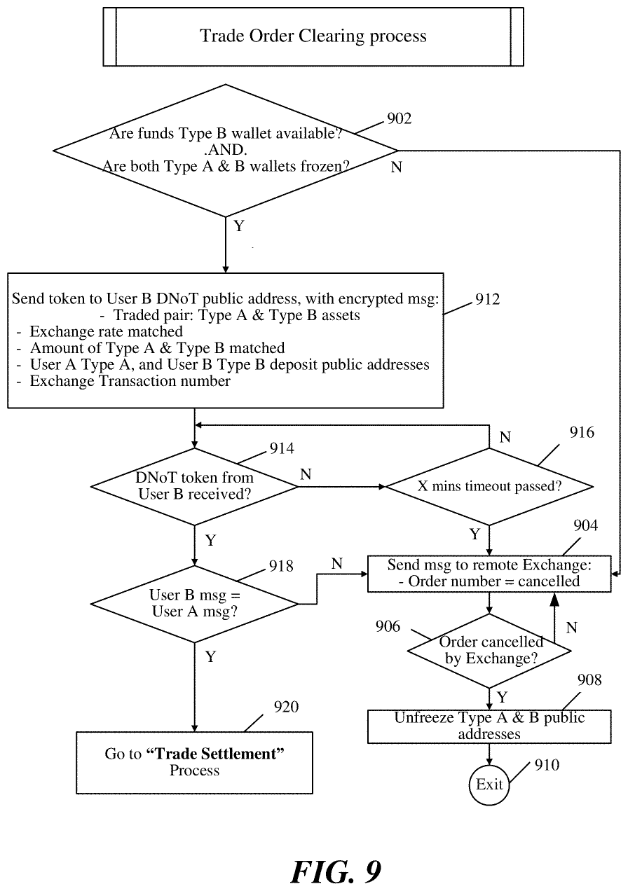

Once the message has been received from the remote exchange, the message may be validated 804. The message may be validated when (1) the order number is equal to the bid order number; (2) the amount of Type A asset is less than or equal to the bid amount of the Type A asset; and (3) the exchange rate is less than or equal to the bid exchange rate. Upon validation of the message, the user terminal proceeds to the “Trade Clearing” process 806 as described below with reference to FIG. 9.

If the message is not validated, the order matching is invalid 808 and a message is sent to the remote exchange with the order number and the instructions to cancel the order 810. Until the user terminal receives a message from the remote exchange acknowledging the order cancellation 812, the cancellation message 810 may continue to be sent to the remote exchange at periodic intervals. Upon receiving confirmation of the order cancellation from the remote exchange, the user terminal may unfreeze the Type A and Type B public addresses 814 and the process is terminated 816.

### Trade Order Clearing Process

FIG. 9 is a block diagram illustrating the detailed process of the trade order clearing process of the transfer of digital assets, according to one aspect. Once a trade order has been placed and a match found and verified, a determination may be made as to whether sufficient funds for the trade are available 902. Determination of available funds may include that there are sufficient Type B funds available in the Type B wallet and that both the Type A and Type B wallets are frozen. If Type B funds are not available and both the Type A and Type B wallets are not frozen, a message is sent to the remote exchange with the order number and the instructions to cancel the order 904. Until the user terminal receives a message from the remote exchange acknowledging the order cancellation 906, the cancellation message 904 may continue to be sent to the remote exchange at periodic intervals. Upon receiving confirmation of the order cancellation from the remote exchange, the user terminal may unfreeze the Type A and Type B public addresses 908 and the process is terminated 910.

Next, the user terminal (User A) may send a token to User B DNoT public address with an encrypted message 912. The encrypted message may include (1) the traded pair, i.e. Type A and Type B assets; (2) the exchange rate matched; (3) the amount of Type A and Type B assets that have been matched, i.e. to be traded or exchanged; (4) the User A Type A deposit public address and the User B Type B deposit public address; and/or (5) the exchange transaction number.

The user terminal (User A) may then determine if the DNoT token from User B has been received 914. If the token has not been received, the user terminal (User A) continually checks for the token until a pre-determined amount of time (X) has passed. If a pre-determined amount of time (X) has passed 916, a message may be sent to the remote exchange with the order number and the instructions to cancel the order 904. Until the user terminal (User A) receives a message from the remote exchange acknowledging the order cancellation 906, the cancellation message 904 may continue to be sent to the remote exchange at periodic intervals. Upon receiving confirmation of the order cancellation from the remote exchange, the user terminal (User A) may unfreeze the Type A and Type B public addresses 908 and the process is terminated 910.

Upon the user terminal of User A receiving the token, the received User B message may be compared to the User A message 918. That is, the encrypted messages 912 are compared. If the User B message does not equal the User A message, a message may be sent to the remote exchange with the order number and the instructions to cancel the order 904. Until the user terminal (User A) receives a message from the remote exchange acknowledging the order cancellation 906, the cancellation message 904 may continue to be sent to the remote exchange at periodic intervals. Upon receiving confirmation of the order cancellation from the remote exchange, the user terminal (User A) may unfreeze the Type A and Type B public addresses 908 and the process is terminated 910.

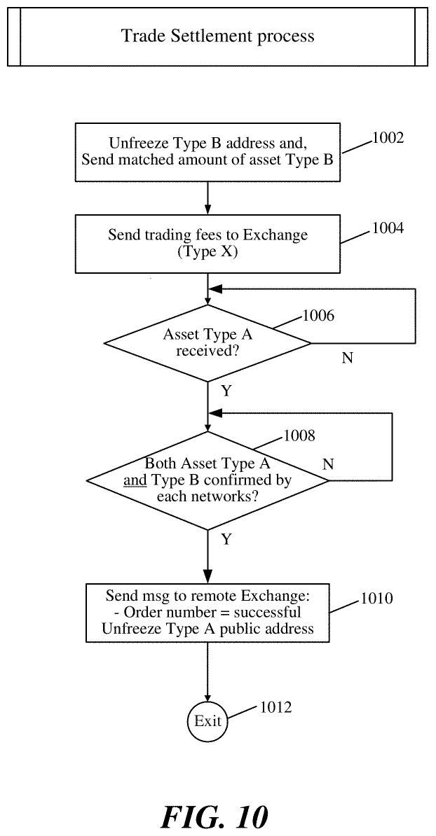

Alternatively, if the User B message equals the User A message, the user terminal (User A) may proceed to the “Trade Settlement” process 920 as described below with reference to FIG. 10.

### Trade Settlement Process

FIG. 10 is a block diagram illustrating the detailed process of the trade settlement process of the transfer of digital assets, according to one aspect. Once the trade order has been cleared, i.e. the verification of sufficient funds, the Type B address may be unfrozen and the matched amount of the Type B asset may be sent to User A 1002 and the trading fees are sent to the exchange 1004. The trading fees may be of Type X where Type X is currency, such as United States Dollars (S).

Next, a determination is made as to whether Asset A has been received by User B 1006. The system may keep checking until asset Type A has been received. Once asset Type A has been received, both asset Type A and asset Type B may be confirmed by each network 1008. The system may keep checking until the confirmation for asset Type A has been received. Once the confirmation has been received, a message may be sent to the remote exchange 1010. The message may indicate that the specific order number was successful (i.e. the transaction was successfully completed) and that asset Type A public address should be unfrozen. The process may then be terminated 1012.

### Alternate Trade Settlement Process

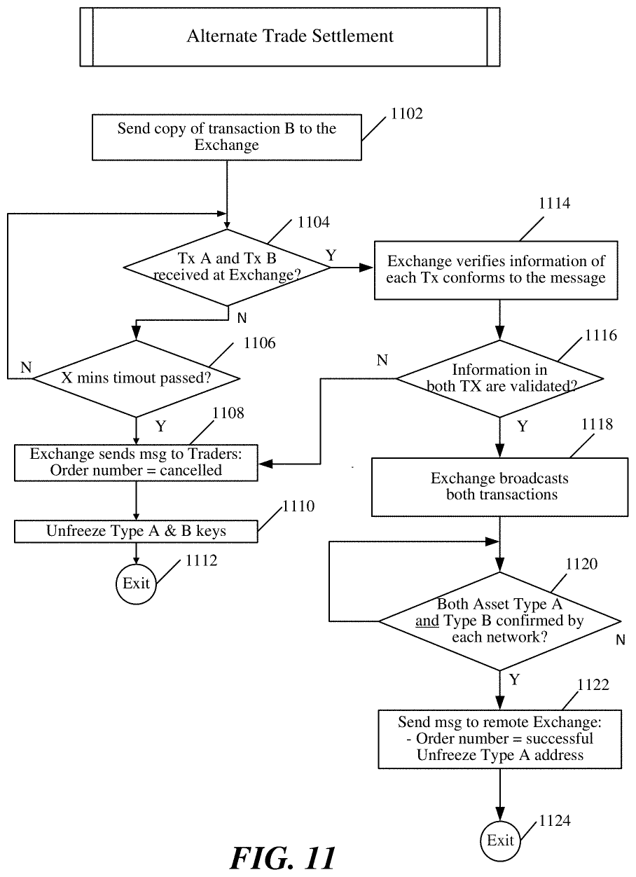

FIG. 11 is a block diagram illustrating the detailed process of the alternate trade settlement process of the transfer of digital assets, according to one aspect. This alternative embodiment may be used when the user terminals (User A and User B) may be at risk of being compromised, which would result in digital assets trading programs or systems on the user terminals being modified maliciously.

In the alternative trade settlement process, a copy of both transaction A and transaction B may be sent to the remote exchange 1102. It may then be determined if both transaction A and transaction B have been received at the remote exchange 1104. If both transaction A and transaction B have not been received at the remote exchange, the user terminal may continually check for confirmation that both transactions have been received at the remote exchange until a pre-determined amount of time (X) has passed 1106. If a pre-determined amount of time (X) has passed, the remote exchange may send a message to each trader (User A and User B) with the order number and the instructions to cancel the order 1108. Once the order has been cancelled, Type A and Type B tokens or public keys are unfrozen 1110 and the process is terminated 1112.

Alternatively, if both transaction A and transaction B and have been received at the remote exchange, the remote exchange may verify that the information in each of the transactions conforms to the message 1114. Next, a determination made be made as to whether or not the information from both transaction A and transaction B are valid or validated 1116. If the information from both transaction is not validated, the remote exchange may send a message to each trader (User A and User B) with the order number and the instructions to cancel the order 1108. Once the order has been cancelled, Type A and Type B tokens or public keys are unfrozen 1110 and the process is terminated 1112.

Alternatively, if the information from both transaction is validated, the remote exchange may broadcast both transactions on Asset A Network and Asset B Network 1118. Next, both asset Type A and asset Type B may be confirmed by each network 1120. Once confirmed, a message may be sent to the remote exchange 1122. The message may indicate that the order has been successful and Type A token or public key is unfrozen and the process is terminated 1124.

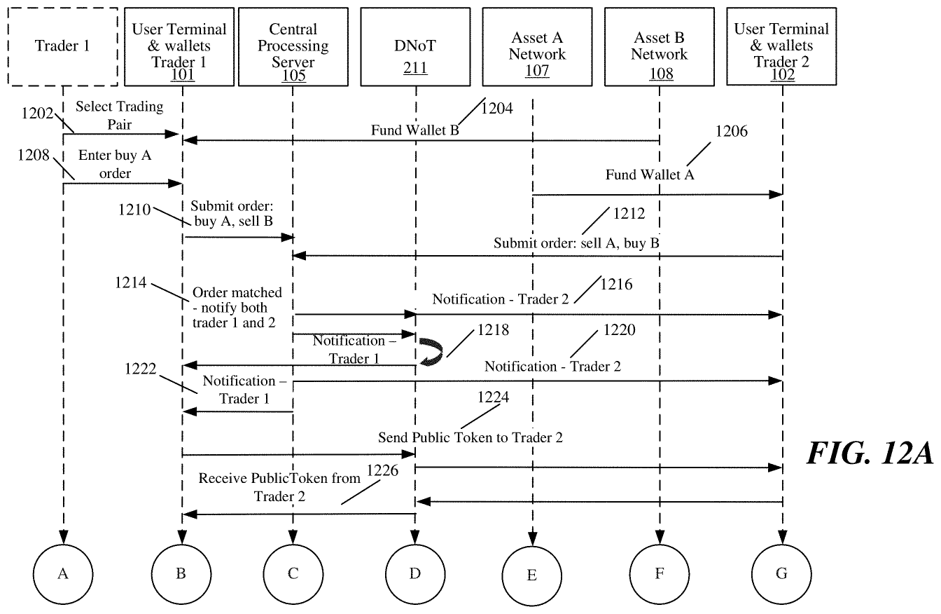

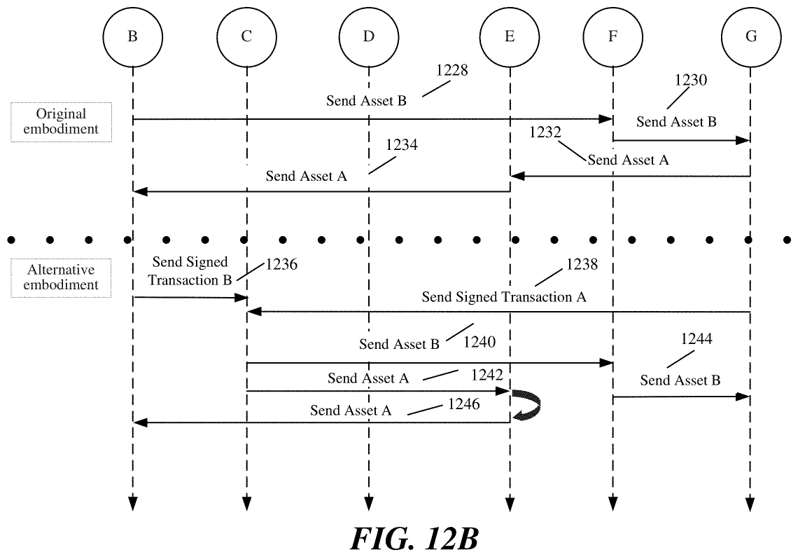

FIGS. 12A and 12B are flow diagrams illustrating the transfer of digital assets, according to one aspect. In this example, the first user terminal and corresponding wallets of Trader 1 101/201, the central processing server 105/205, the DNoT 211, Asset A Network 107, Asset B Network 108 and the second user terminal and corresponding wallets of Trader 2 102/202 of FIGS. 1 and 2 are used for illustration purposes.

First, a trader (e.g. Trader 1) may select a trading pair 1202. The trading pair may include assets which Trader 1 currently owns (e.g. Asset B) and is willing to part with (e.g. by exchanging, trading, selling, etc.) in order to acquire a different asset (e.g. Asset A). For example, Trader 1 may decide that he would like to acquire Asset A by trading or exchanging Asset B with another trader (e.g. Trader 2). Once the decision to acquire Asset A has been made, Trader 1 may then determine, via Asset Network B, if the wallet associated with his Asset B on the user terminal 101 is sufficiently funded 1204. That is, if the wallet has enough of Asset B to complete the transaction for Asset A. If there are not enough funds of Asset B in the wallet, Trader 1 may add additional funds (i.e. Asset B) to the wallet by transferring the additional funds from a user terminal (or any other way known in the art) belonging to Trader 1 so that the wallet is sufficiently funded with Asset B. Alternatively, Trader 1 may opt to lower his price for Asset B.

In addition to verifying that there is a sufficient amount of Asset B available, an internal step by the user terminal 101 of Trader 1 of verifying that wallet A is installed on the user terminal 101 of Trader 1 is performed. This step is performed so that once a match has been identified, the user terminal 101 of Trader 1 will be able to provide a receiving address for Asset A to Trader 2 to complete the transaction by transferring the assets.

At any time another trader, such as Trader 2, may also decide to sell, trade or exchange an asset. For example, Trader 2 may decide to sell, trade or exchange Asset A. Similarly with the user terminal 101 of Trader 1, the user terminal 102 of Trader 2 may then determine, via Asset Network A, if the wallet associated with his Asset A on the user terminal 102 is sufficiently funded 1206. If the wallet is not sufficiently funded, Trader 2 may add additional funds (i.e. Asset A) to the wallet by transferring the additional funds from a user terminal, for example, belonging to Trader 2 so that the wallet is sufficiently funded with Asset A. Alternatively, Trader 2 may opt to lower his price for Asset A. Although this step is shown prior to Trader 1 submitting an order to the exchange, this is by way of example only and Trader 2 may begin the process of selling, trading, purchasing and/or exchanging an asset at any time.

Returning to Trader 1, once Trader 1 has determined that there is enough Asset B in the wallet on its user terminal, Trader 1 may submit an order, using the user terminal, to the exchange to acquire Asset A by agreeing to relinquish some or all of Asset B located in or associated with the wallet (i.e. wallet B) on Trader 1's user terminal 1208. Next, the order, which may be encrypted, to buy Asset A and sell Asset B may then be submitted to the central processing server 1210. As discussed previously, the order transmitted to the central processing server may include information such as (1) the type of electronic asset to trade; (2) the amount of electronic asset to Buy, or Sell; (3) the desired exchange rate/price; (4) the desired electronic asset wallet deposit address or public key, which is specific to the electronic asset network type, and/or; (5) a unique self-generated transaction identifier, which may include the trader identifier corresponding to a DNoT network public key, as generated by the wallet manager module (or circuit) and the DNoT node on the user terminal of the trader.

Trader 2 may submit an order, which may be encrypted, to sell Asset A and buy Asset B, using a second user terminal, to the central processing server 1212. As discussed previously, the order transmitted to the central processing server may include information such as (1) the type of electronic asset to trade; (2) the amount of electronic asset to Buy, or Sell; (3) the desired exchange rate/price; (4) the desired electronic asset wallet deposit address or public key, which is specific to the electronic asset network type, and/or; (5) a unique self-generated transaction identifier, which may include the trader identifier corresponding to a DNoT network public key, as generated by the wallet manager module (circuit) and the DNoT node on the user terminal of the trader. Although the submission of the order by Trader 2 is shown after the submission of the order by Trader 1, this is by way of example only and Trader 2 may submit an order to the central processing server at any time.

The central processing server 105 may manage the orders received from all user terminals of the system participants in the selected trading pair and attempt to match orders received. Once a trade match has been found (in terms of quantities and price) 1214, the matching trade may be removed from the Order Market and the central processing server may send a transaction message or notification to each user terminal of the traders involved in the trade, which includes the trade specifications. According to one example, all orders submitted by Traders to the central processing server may remain on the books until a match is found.

After the central processing server finds a match, notifications may be provided to Trader 1 and Trader 2 by the central processing server. According to one example, each Trader may be provided two (2) notifications, each on a separate network. The central processing server may notify Trader 2 of the match by sending a notification through the de-centralized network of traders (DNoT) which then transmits the notification to the user terminal of Trader 2 1216. Similarly, the central processing server may notify Trader 1 of the match by sending a notification through the de-centralized network of traders (DNoT) which then transmits the notification to the user terminal of Trader 1 1218.

Alternatively, or jointly, the central processing server may notify Trader 2 of the match directly through the communication link that was used when the order was submitted to the central processing server 1220. The communication link may be TCP/IP, SSL or a typical Internet connection.

Alternatively, or jointly, the central processing server may notify also Trader 1 of the match directly through the communication link that was used when the order was submitted to the central processing server. The communication link may be TCP/IP, SSL or a typical Internet connection 1222.

According to one example, there may be added security when notifying the user terminal of each Trader using two separate networks which provides proof that the exchange has notified both Traders. The DNoT is public proof that the exchange has done its job and advised the traders.

Next, the user terminal of Trader 1 may send its public token, via DNoT, to the user terminal of Trader 2 1224 while the user terminal of Trader 1 may receive the public token of Trader 2 from Trader 2 via the DNoT 1226. As described previously, each token may include an encrypted or hashed message with (1) the traded pair, i.e. Type A and Type B assets; (2) the exchange rate matched; (3) the amount of Type A and Type B assets that have been matched, i.e. to be traded or exchanged; (4) the Trader 1 Type A deposit public address and the Trader 2 Type B deposit public address; and/or (5) the exchange transaction number.

In one configuration, after the public tokens have been exchanged between Trader 1 and Trader 2, Trader 1, via its user terminal 101, may release or send Asset B to the Asset B network 1228. The Asset B network may then release or send Asset B to Trader 2 via its user terminal 1230. Similarly, after the public tokens have been exchanged between Trader 1 and Trader 2, Trader 2, via its user terminal 102, may release or send Asset A to the Asset A network 1232. The Asset A network may then release or send Asset A to Trader 1 via its user terminal 1234.

In an alternate configuration, Trader 1 and/or Trader 2 may not trust each other as one or both user terminals may be compromised, for example, and one or both of the Traders may require cryptographic signatures or signed transactions as discussed above with reference to FIG. 6. As shown in FIG. 12B, Trader 1 may send its signed transaction (Transaction B) to the central processing server or exchange 1236 and Trader 2 may send its signed transaction (Transaction A) to the central processing server or exchange 1238. Once the central processing server or exchange has received both signed transactions which have been double checked or verified again to ensure that the assets have not been double spent during that time, the central processing server or exchange may then broadcast (or transmit/send/transfer) the assets at the same time on the respective networks. That is, the central processing server or exchange may broadcast or send Asset B to the Asset B Network 1240 while simultaneously broadcasting or sending Asset A to the Asset A Network 1242. The Asset B Network may then send Asset B to the user terminal 102 of Trader 2 1244 and the Asset A Network may then send Asset A to the user terminal 101 of Trader 1 1246 completing the trading digital assets using a de-centralized escrow service.

### User Terminal

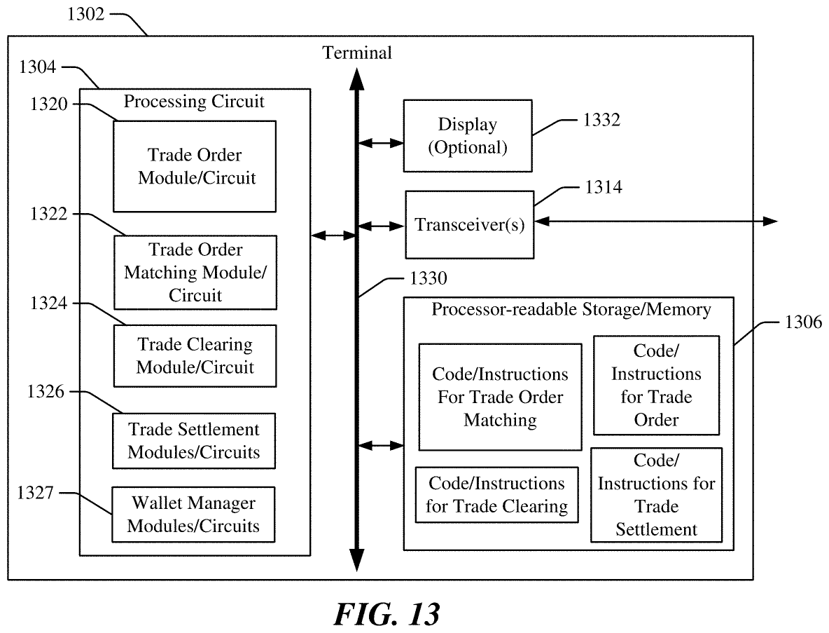

FIG. 13 is a diagram 1300 illustrating an example of a hardware implementation of a processing circuit for a system configured to trade digital assets using a de-centralized escrow service.

The terminal 1302 may include a processing circuit 1304. The processing circuit 1304 may be implemented with a bus architecture, represented generally by the bus 1330. The bus 1330 may include any number of interconnecting buses and bridges depending on the application and attributes of the processing circuit 1304 and overall design constraints. The bus 1330 may link together various circuits including one or more processors and/or hardware modules, processing circuit 1304, and the processor-readable medium 1306. The bus 1330 may also link various other circuits such as timing sources, peripherals, and power management circuits, which are well known in the art, and therefore, will not be described any further.

The processing circuit 1304 may be coupled to one or more communications interfaces or transceivers 1314 which may be used for communications (receiving and transmitting data) with entities of a network.

The processing circuit 1304 may include one or more processors, communicatively coupled, responsible for general processing, including the execution of software stored on the processor-readable medium 1306. For example, the processing circuit 1304 may include one or more processors deployed in terminals 101-104 of FIG. 1, terminals 201-204 of FIG. 2 and/or the terminal 400 of FIG. 4, for example. The software, when executed by the one or more processors, cause the processing circuit 1304 to perform the various functions described supra for any particular terminal. The processor-readable medium 1306 may also be used for storing data that is manipulated by the processing circuit 1304 when executing software. The processing system further includes at least one of the modules 1320, 1322, 1324, 1326 and 1327. The modules 1320, 1322, 1324, 1326 and 1327 may be software modules running on the processing circuit 1304, resident/stored in the processor-readable medium 1306, one or more hardware modules coupled to the processing circuit 1304, or some combination thereof.

In one configuration, the terminal 1302 for wired or wireless communication includes a module or circuit 1320 configured to receive verbal or written trade orders from a user or trader and verify all applicable wallets are installed on the user terminal, a module or circuit 1322 configured to communicate with a remote exchange for placing the trade order and receiving notification from the remote exchange of a match for the trade order, a module or circuit 1324 configured to verify that the assets or funds which will be traded are available and locked or frozen, a module or circuit 1326 configured to send the assets being traded and unlocking the wallets, and a module or circuit 1327 for managing the digital wallets associated and/or linked to the terminal.

In one configuration, the terminal 1302 may optionally include a display or touch screen 1332 for receiving and displaying data to the consumer.

One or more of the components, steps, and/or functions illustrated in the figures may be rearranged and/or combined into a single component, step, or function or embodied in several components, steps, or functions without affecting the operation of the communication device having channel-specific signal insertion. Additional elements, components, steps, and/or functions may also be added without departing from the invention. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The terms “machine-readable medium”, “computer-readable medium”, and/or “processor-readable medium” may include, but are not limited to portable or fixed storage devices, optical storage devices, and various other non-transitory mediums capable of storing, containing or carrying instruction(s) and/or data. Thus, the various methods described herein may be partially or fully implemented by instructions and/or data that may be stored in a “machine-readable medium”, “computer-readable medium”, and/or “processor-readable medium” and executed by one or more processors, machines and/or devices.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

While certain exemplary embodiments have been described and shown in the accompanying drawings, it is to be understood that such embodiments are merely illustrative of and not restrictive on the broad application, and that this application is not be limited to the specific constructions and arrangements shown and described, since various other modifications may occur to those ordinarily skilled in the art.

1. A computer implemented method for trading assets using a de-centralized escrow service, comprising executing on a processor the steps of:
receiving an electronic communication in a computer terminal with a memory module, a wallet manager module, an order module, an order matching module, a clearing module and a settlement module, the electronic communication is a trade order for a pair of assets requested by a first user;
installing a digital assets trading program on the user terminal;
verifying the user terminal is fitted with a first digital wallet and a second digital wallet corresponding to the pair of assets using the wallet manager module;
funding the first digital wallet on the computer terminal by securely transferring a first asset of the pair of assets to the first digital wallet and freezing an amount of the first asset to be traded for a second asset in the pair of assets;
establishing a communication link to a central processing server and submitting the trade order to the central processing server using the order module; and
receiving notification from the central processing server of a trade order match module using the order matching module.

2. The method of claim 1, further comprising executing on the processor the step of confirming matching information received in the notification from the central processing server, the matching information is selected from at least the type of asset, conversion rates and amounts of the pair of assets are within boundaries of the trade order using the trade order match module.

3. The method of claim 2, further comprising executing on the processor the step of generating a first set of cryptographic keys and a second set of cryptographic keys on the user terminal; and wherein the first user controls the first set of cryptographic keys and the digital assets trading program installed on the user terminal controls the second set of cryptographic keys.

4. The method of claim 3, further comprising executing on the processor the step of verifying availability of the amount of the first asset to be traded.

5. The method of claim 4, further comprising executing on the processor the step of sending a first token having first token information to the second user using a de-centralized network of traders.

6. The method of claim 5, wherein the first token information includes de-centralized network of traders address of the first user, sending and receiving addresses of the first and second digital wallets of the first user, and a unique transaction identifier received from the central processing server.

7. The method of claim 6, further comprising executing on the processor the step of receiving a second token having second token information from the second user using the de-centralized network of traders.

8. The method of claim 7, wherein the second token information includes de-centralized network of traders address of the second user, sending and receiving addresses of digital wallets of the second user, and the unique transaction identifier received from the central processing server.

9. The method of claim 8, further comprising executing on the processor the step of verifying the unique transaction identifier received in the first token is the same as the unique transaction identifier in the second token.

10. The method of claim 9, further comprising executing on the processor the step of sending the amount of the first asset to the receiving address of a second user digital wallet of the second user.

11. The method of claim 10, further comprising executing on the processor the step of receiving the second asset in the receiving address of second digital wallet of the first user.

12. The method of claim 11, further comprising executing on the processor the step of unfreezing the first and second digital wallets.

13. The method of claim 10, further comprising executing on the processor the step of sending a copy of a signed transaction for the second asset to the central processing server for comparison to a copy of a signed transaction for the first asset from the second user.

14. The method of claim 13, further comprising executing on the processor the step of sending the second asset to the second user digital wallet after the central processing server confirms the validity of the copy of the signed transaction for second asset and the copy of the signed transaction for the first asset.

15. The method of claim 14, wherein the central processing server confirms the validity of the signed transactions by broadcasting the transaction on a first asset network and a second asset network.

16. The method of claim 15, wherein the receiving addresses of the second digital wallet of the first user is unfrozen.

17. A computer terminal for trading assets using a de-centralized escrow service, the terminal comprising:
a processing circuit;
a communications interface communicatively coupled to the processing circuit for transmitting and receiving information; and
a memory communicatively coupled to the processing circuit for storing information, wherein the processing circuit is configured to:
receive an electronic communication, the electronic communication is a trade order for a pair of assets requested by a first user;
install a digital assets trading program on the user terminal;
verify the user terminal is fitted with a first digital wallet and a second digital wallet corresponding to the pair of assets using a wallet manager module communicatively coupled to the processor;
fund the first digital wallet on the computer terminal by securely transferring a first asset of the pair of assets to the first digital wallet and freezing an amount of the first asset to be traded for a second asset in the pair of assets;
establish a communication link to a central processing server and submitting the trade order to the central processing server using an order module communicatively coupled to the processing circuit; and
receive notification from the central processing server of a trade order match module using the order matching module.

18. The computer terminal of claim 17, wherein the processor is further configured to confirm matching information received in the notification from the central processing server, the matching information is selected from at least the type of asset, conversion rates and amounts of the pair of assets are within boundaries of the trade order using the trade order match module.

19. The computer terminal of claim 18, wherein the processor is further configured to:
verify the availability of the amount of the first asset to be traded;
send a first token having first token information to the second user using a de-centralized network of traders, where the first token information includes de-centralized network of traders address of the first user, sending and receiving addresses of the first and second digital wallets of the first user, and a unique transaction identifier received from the central processing server;
receive a second token having second token information from the second user using the de-centralized network of trader, where the second token information includes de-centralized network of traders address of the second user, sending and receiving addresses of digital wallets of the second user, and the unique transaction identifier received from the central processing server; and
verify the unique transaction identifier received in the first token is the same as the unique transaction identifier in the second token.

20. The computer terminal of claim 17, wherein the processor is further configured to:
send the amount of the first asset to the receiving address of a second user digital wallet of the second user;
receive the second asset in the receiving address of second digital wallet of the first user; and
unfreezing the first and second digital wallets.
